(19) United States
(12) Patent Application Publication
(10) Pub. No.: US 2015/0056504 A1
(43) Pub. Date: Feb. 26, 2015

(54) MANGANESE AND IRON ELECTRODE CELL

(71) Applicant: ENCELL TECHNOLOGY, INC., Alachua, FL (US)

(72) Inventor: Randy Gene Ogg, Newberry, FL (US)

(73) Assignee: ENCELL TECHNOLOGY, INC., Alachua, FL (US)

(21) Appl. No.: 14/464,613

(22) Filed: Aug. 20, 2014

Related U.S. Application Data
(60) Provisional application No. 61/867,947, filed on Aug. 20, 2013.

(51) Int. Cl. H01M 4/24; H01M 10/26; H01M 4/50; H01M 4/62; H01M 4/80

(52) U.S. Cl. CPC H01M 4/248; H01M 4/622; H01M 4/625; H01M 4/808; H01M 4/50; H01M 4/24; H01M 10/26; H01M 4/366
USPC 429/206; 429/221; 429/217

(57) ABSTRACT

Provided is a Mn—Fe battery comprising an iron based anode and a manganese cathode. The manganese cathode comprises a compressed metal foam substrate with the manganese active material present throughout the substrate. The metal foam substrate containing the manganese active material is also compression sized between about 42 and 45%.

### RELATED APPLICATION

This application claims priority to U.S. Provisional Application Ser. No. 61/867,947, filed Aug. 20, 2013, which application is incorporated herein by reference in its entirety.

### BACKGROUND

1. Technical Field

The present subject matter is in the technical field of energy storage devices. More particularly, the present subject matter is in the technical field of rechargeable batteries employing an iron electrode and a manganese electrode.

2. Background of the Invention

Iron electrodes have been used in energy storage batteries and other devices for over one hundred years. In particular, iron electrodes are often combines with a nickel-based positive electrode in alkaline electrolyte to form a nickel-iron (Ni—Fe) battery. The Ni—Fe battery is a rechargeable battery having a nickel (III) oxy-hydroxide positive electrode in combination with an iron negative electrode with an alkaline electrolyte such as potassium hydroxide.

Traditionally, the iron electrode active material is produced by dissolving pure iron powder in sulfuric acid, followed by drying and roasting to produce iron oxide (Fe₂O₃). The material is washed and partially reduced in hydrogen and partially oxidized to give a mix of Fe and magnetite (Fe₃O₄). Additives such as FeS may be added to the active material mass. The negative electrode structure is typically that of a pocket plate construction wherein the active material is introduced into the current collector. The current collector is made up of steel strips or ribbons that are perforated and nickel plated and the strip is formed into a tube or pocket with one end left for introduction of the active material (D. Linden and T. Reddy, Editors, “Handbook of Batteries, Third Edition”, McGraw-Hill©2002).

The Ni—Fe battery is a very robust battery which is very tolerant of abuse such as overcharge and over discharge and can have a very long life. It is often used in backup situations where it can be continuously trickle-charged and last more than 20 years.

The Ni—Fe batteries have been displaced by other battery technologies due to the high cost of manufacturing. While the technology of preparing iron electrodes is well known and the current preferred process for making theses electrodes is a pocket design, pocket design electrodes are also difficult to produce in high volumes and the energy and power utilization from this design is low. The industry would be well served by a low cost, high quality and high performance iron electrode design and manufacturing process.

Other forms of electrode production are known in the art, particularly electrodes of a pasted construction. This type of electrode typically incorporated a binder with the active material, which can then be coated onto a two or three dimensional current collector, dried, and compacted to from the finished electrode.

U.S. Pat. No. 3,853,624 describes a Ni—Fe battery incorporating iron electrodes employing a metal fiber structure which is loaded with sulfurized magnetic iron oxide by a wet pasting method. The plates are electrochemically formed outside the cell to electrochemically attach the iron active materials to the plaque structure. Such a process in unwieldy in high volume manufacturing and adds to produce cost.

U.S. Pat. No. 4,021,911 describes an iron electrode wherein the iron active mass is spread onto a grid and rolled and dried. The electrode is then treated with an epoxide resin solution to form a solid reinforcing film-like layer on the electrode surface. However, it can be expected that such a surface film would contribute to an insulating nature to the electrode surface, significantly increasing charge transfer resistance and lowering the cell's ability to sustain high charge and/or discharge rates.

Pasted electrodes using various binders have been proposed for alkaline electrodes most particularly for electrodes employing the hydrogen-absorbing alloys for NiMH batteries (for example U.S. Pat. No. 5,780,184). However, the desired properties for these electrodes differ significantly from those desired for a high capacity iron electrode. In the case of the MH electrode, high electrode density (low porosity) is required to maintain good electrical contact between the alloy particles and to facilitate solid-state hydrogen diffusion in the alloy. By contrast, high porosity is desirable for iron electrodes due to the low solubility of the iron oxide species. Hence, binder system developed for other types of alkaline electrodes have not been optimized for Fe—Ni batteries and hence have not found commercial application.

The industry, however, would be greatly served by a battery, e.g., a Ni—Fe or Mn—Fe battery, which shows improved performance. The uses would thereby be increased. A battery with an iron anode having improved efficiency, charge retention and cycle like would be greatly welcome.

### SUMMARY OF THE INVENTION

The present invention provides one with a Mn—Fe battery having improved performance characteristics. In one embodiment, the iron anode comprises a single layer substrate coated on at least one side with a coating comprising an iron active material and a binder. The anode is prepared by coating the substrate with a coating mixture comprising iron active material and a binder. In one embodiment, the manganese electrode comprises manganese containing compressed metal foams. The metal foam containing the manganese active material has a compression sizing between about 42 and 45%. The battery cell can use a particular electrolyte and/or battery separator. The resulting characteristics of efficiency, charge retention and cycle life are much improved over iron anode batteries in the prior art.

### BRIEF DESCRIPTION OF THE FIGURES OF THE DRAWINGS

FIG. 1 is a perspective view of a coated iron electrode of the present invention.

FIG. 2 is a side view and cross-section view of an iron electrode coated on both sides of the substrate in accordance with the present invention.

FIG. 3 is a perspective view of a current pocket iron electrode.

FIG. 4 is a side view and a cross-section view of a current pocket iron electrode.

FIG. 5 depicts a battery having an iron electrode and a manganese electrode.

### DETAILED DESCRIPTION OF THE INVENTION

The invention comprises a Mn—Fe battery with an iron anode and a manganese cathode. In one embodiment, the manganese electrode comprises compressed metal foam containing manganese active material. The manganese active material generally comprises manganese dioxide. The metal foam is compressed while filled with the manganese active material. The compression sizing is between about 42 and 45%. The battery, in one embodiment, comprises an iron electrode comprised of a single, coated conductive substrate, prepared by a simple coating process, which can be continuous. The substrate can be coated on one side or on both sides. The combination of such an iron electrode with such a manganese cathode provides one with a battery cell of enhanced power, capacity, and efficiency.

The substrate is used as a current conducting and collecting material that houses the active material of the electrode. The cathode paste comprises active manganese metal powders mixed with aqueous or organic binder to create a paste that can be consistently coated on one or both sides of a substrate. The substrate holds the active material (i.e., the paste) and acts as a current collector. In one embodiment, the substrate for the cathode is made of a conductive material such as steel, Ni, or Cu, and may be plated with indium or Ni (i.e., a material that is non-active relative to MnO₂). In one embodiment, the substrate comprises a porous conductive substrate such as, for example, perforated metal, metal foam, metal felt, expanded metal, or carbon foam. More specifically, the substrate comprises for the manganese cathode nickel foam and/or copper plated nickel foam. Accordingly, the cathode paste is coated on and throughout the foam mesh.

The coated cathode substrate is dried and sized (i.e., compressed) to create a highly conductive, dense, porous electrode. In metal foams, typically 75-95% of the volume consists of void spaces. As such, the use of metal foams allows for thicker electrode substrates without increasing the resistance of the electrode substrates. Target compression from sizing for this embodiment is between about 42% and 45%, which gives desirable porosity, required for low resistance/high rate performance of the rechargeable flat plate electrode cell.

Without wishing to be bound by any theories, it is believed that the high density of compression reduces the resistance within the paste by reducing the distance between active particles in the active material and reduces the resistance to the substrate by bringing the active particles closer to it. The high density reduces the volume so the energy density is increased. The high density also reduces the void volume in the active material which reduces the amount of electrolyte required to fill the electrode which in turn reduces the rate at which dendrites are formed which protects the cell from shorting and increases cycle life. The density level is critical since over-compression will cause dry spots in the active material where electrolyte cannot get to. These dry spots are very high resistance which reduces performance and can create gassing areas which cause cell failure. It has also been found for the manganese cathode that if the compression is less than 42% the manganese can leak out and thereby effect the performance of the battery cell. If the compression is greater than about 45%, it has been found that the system can close up. Therefore, sizing compression between 42 and 45% for the manganese cathode is important.

Without the foregoing sizing, desired energy density and high power capability are not achieved. The target coated sized thickness for the cathode is less than about 0.0300 inches. Coated sized thickness for the cathode greater than about 0.0300 inches results in rate capability (power) losses; while coated sized thickness for the cathode less than about 0.0200 inches results in energy density losses, due to excess inter electrode spacing and substrate relative to active material.

In one embodiment, the cathode paste comprises about 70-90 weight % electrolytic manganese dioxide; about 2-15 weight %, for example, about 7.5 weight %, graphite and/or carbon black; about 3-10 weight %, for example, about 6 weight %, polymeric binder; about 1-15 weight %, for example, about 5 weight %, barium compound; and about 0.01-10 weight %, for example, about 5 weight %, hydrogen recombination catalyst. Exemplary barium compounds include barium oxide, barium hydroxide, and barium sulfate. Exemplary hydrogen recombination catalysts include silver, silver oxides, and hydrogen absorbing alloys. The cathode paste may further comprise indium.

Exemplary polymeric binders for the cathode paste include carboxym ethyl cellulose (CMC), polyacrylic acid, starch, starch derivatives, polyisobutylene, polytetrafluoroethylene, polyamide, polyethylene, and a metal stearate. The polymeric binder of either the cathode paste or anode paste can include conductive graphite, for example, conductive graphite having an average particle size between 2 and 6 microns. In one embodiment, the binder comprises CMC, in an amount of 2 wt % of the cathode paste.

With regard to the iron anode, in the current pocket design used commercially, the substrate encompasses the active material and holds the material. Two layers of substrate are therefore required per electrode. In the present invention, a single layer of substrate is used. This single layer acts as a carrier with coated material bonded to at least one side. In one embodiment, both sides of the substrate are coated. This substrate may be a thin conductive material such as a perforated metal foil or sheet, metal mesh or screen, woven metal, or expanded metal. The substrate can also be a three-dimensional material as a metal foam or felt. For example, a nickel plated perforated foil can be used.

The coating mix is a combination of binder and active materials in aqueous or organic solution. The mix can also contain other additives such as pore formers. Pore formers are often used to insure sufficient H₂ movement in the electrode. Without sufficient H₂ diffusion, the capacity of the battery will be adversely affected. Conductive additives such as a carbon or Ni powder can also be used in the coating mix. The binder materials have properties that provide adhesion and bonding between the active material particles, both to themselves and to the substrate current carrier. The binder is generally resistant to degradation due to aging, temperature, and caustic environment. The binder can comprise polymers, alcohols, rubbers, and other materials, such as an advanced latex formulation that has been proven effective. A polyvinyl alcohol binder is used in one embodiment.

The active material for the mix formulation is selected from iron species that are generally less oxidative. Such materials include metal Fe and iron oxide materials. The iron oxide material will convert to iron metal when a charge is applied. A suitable iron oxide material includes Fe₃O₄. In addition, any other additives are generally required to be of a less oxidative nature, such as sulfur, antimony, selenium, and tellurium.

The coating method can be a continuous process that applies the active material mixture to the substrate such as spraying, dip and wipe, extrusion, low pressure coating die, or surface transfer. A batch process can also be used, but a continuous process is advantageous regarding cost and processing. The coating mixture has to maintain a high consistency for weight and thickness and coating uniformity. This insures that the finished electrodes will have similar loadings of active material to provide uniform capacity in the finished battery produced.

The coating method is conducive to layering of various materials and providing layers of different properties such as porosities, densities and thicknesses. For example, the substrate can be coated with three layers. The first layer being of high density, second layer of medium density, and final layer of a lower density to create a density gradient. This gradient improves the flow of gases from the active material to the electrolyte, and provides better electrolyte contact and ionic diffusion with the active material throughout the structure of the electrode.

After coating, the iron electrode is dried to remove any residual liquid, i.e., aqueous or organic solvent. The drying methods will generally provide a continuous method for liquid removal from the coated active material which will enhance the adhesion and binding effects of the dry constituents without iron ignition. This drying method provides a uniform and stable active material coating with the substrate material. Two stages of drying can be used. For example, the first can be radiation for bulk drying, for cost and quality control, followed by convection drying to remove the remaining liquid. The radiation used can be any radiation, such as infrared, microwave or UV, and is very fast. In one embodiment, IR is used; however, the radiation creates a high temperature at the surface of the coated electrode. The high temperature is fine as long as sufficient water is still present to act as a heat sink. Therefore, the water is generally removed to about 10-20 wt % water. This can generally be determined using a control chart. Going below 10 wt % water is dangerous, as the electrode becomes too dry and the high temperature can ignite the iron. Thus, using the convention drying to complete the removal of water/liquid is a preferred embodiment, once the amount of water remaining is in the 10-20 wt % range. In another embodiment, radiation can be used to complete the drying if the process is conducted in an inert atmosphere.

The compaction methods used can be accomplished by rolling mill, vertical pressing, and magnetic compaction of the active material to the desired thickness from 0.005 to 0.500 inches and porosities from 10% to 50%, for high quality and low cost continuous processing. In one embodiment, the porosity of the electrode is from 15-25% porosity. These compaction methods can be used in conjunction with the layering method described above for providing material properties of density, thickness, porosity, and mechanical adhesion.

In addition, continuous in-line surface treatments can be applied continuously throughout any of the steps including coating, layering, and drying processes. The treatments can apply sulfur, polymer, metal spray, surface lament, etc. In one embodiment, a polymer post-coat is applied.

The battery can be made as is conventional, with a standard electrolyte and battery separator. The electrolyte, for example, can be a potassium hydroxide based electrolyte.

In one embodiment, the electrolyte used is a sodium hydroxide based electrolyte, with the sodium hydroxide generally having a concentration of 5-7N in the electrolyte. In one embodiment, the electrolyte comprises sodium hydroxide, lithium hydroxide and sodium sulfide. For example, the sodium hydroxide concentration in the electrolyte is about 6N, the lithium hydroxide concentration in the electrolyte is about 1N, and the sodium sulfide concentration in the electrolyte is about 2 wt %. In using this electrolyte with an iron anode battery, it has been discovered that the life, capacity and power of the battery is much improved. It is believed that the use of the sodium hydroxide based electrolyte reduces the iron solubility in the electrolyte, which extends the battery life. The entire cell is also more stable and effective at high temperatures. The lithium hydroxide increases charge acceptance of the positive, which increases capacity. The presence of the sodium sulfide has been discovered to be important for the effective deposit of sulfur on the iron anode. A battery with an iron anode seems to work better with sodium sulfide in the electrolyte, as the sulfide ends up in the iron anode as a performance enhancer after a few cycles. The sodium sulfide in essence is believed to increase the effective surface area of the iron, so one obtains more utilization of the iron. The capacity and power is therefore improved. Overall, it is believed that use of the present electrolyte improves the capacity, increases the power; reduces gassing; and, improves efficiency.

The battery separator that can be used in the present battery, either alone without the sodium hydroxide based electrolyte, but preferably in combination with the electrolyte, is one that is iron-phobic. The separator can be etched for wettability, but this is merely optional when using the present battery separator. The battery separator is made of a polymer, with a generally smooth surface. The polymer can be any polymer which provides a non-polar surface, which is also generally very smooth. Examples of such polymers include polyolefins, such as polyethylene, and polytetrafluoroethylene (e.g., Teflon®). By using a separator which is more iron-phobic, the separator picks up iron at a slower rate. This results in a significant increase in the cycle life of the battery. Use of the separator is believed to improve the capacity; improve the power; and, the efficiency of a Mn—Fe cell at least 10%. When the separator is used with the sodium hydroxide based electrolyte of the present invention, the life of a standard Mn—Fe battery is believed to increase at least threefold.

The present batteries including the iron and manganese electrodes can be used, for example, quite effectively in a cellphone, thereby requiring an iron electrode with only a single side coated. However, both sides are preferably coated allowing the battery to be used in many applications as is known in the art. For example, the battery cell can be utilized in a vehicle for starting an internal combustion engine. In a more portable format, besides a cellphone, the present battery can be used in power tools and portable electronic devices.

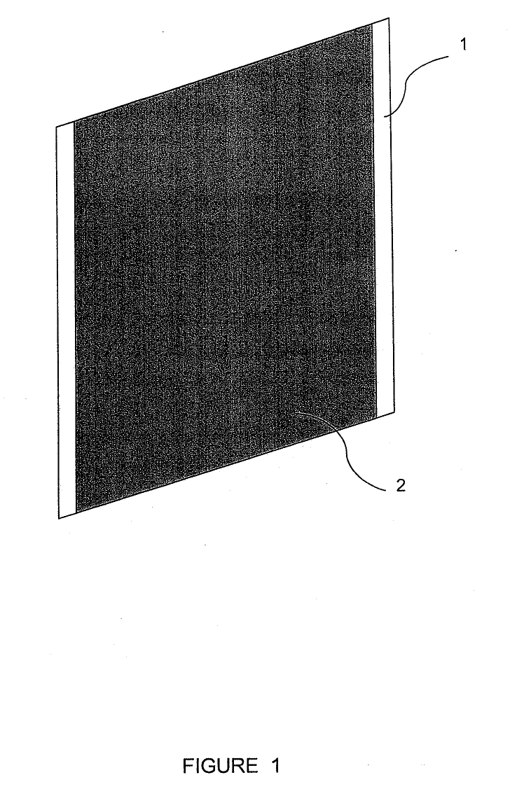

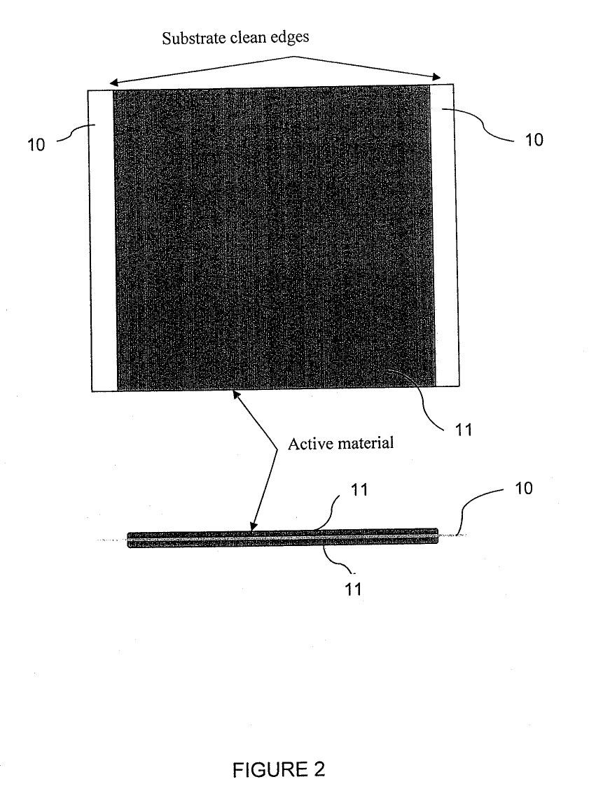

Turning to the figures of the drawing, FIG. 1 is a prospective view of a coated iron electrode. The substrate 1 is coated on each side with the coating 2 comprising the iron active material and binder. This is further shown in FIG. 2. The substrate 10 is coated on each side with the coating 11 of the iron active material and binder.

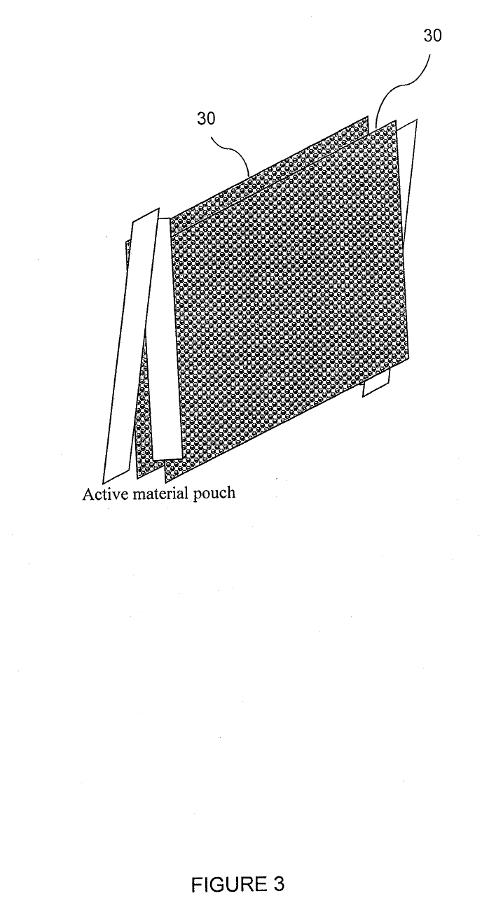

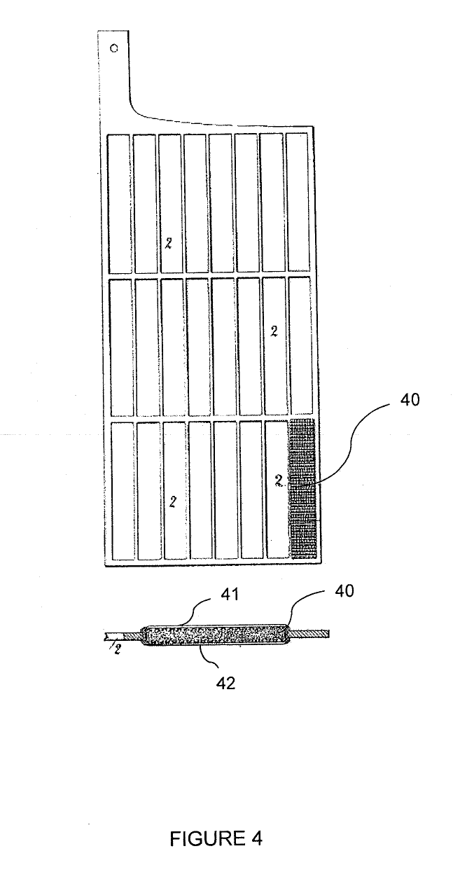

FIGS. 3 and 4 of the drawing show a conventional pocket iron electrode. In FIG. 3, the two substrates 30 are shown to form the pocket which holds the iron active material. In FIG. 4, the iron active material 40 is held between the two substrates 41 and 42.

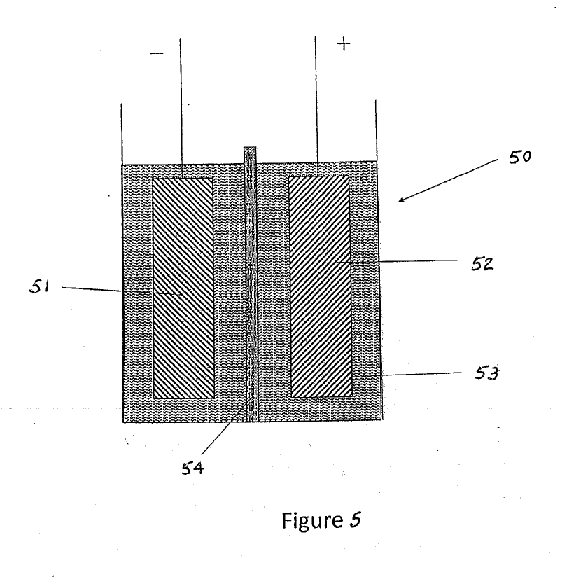

FIG. 5 depicts a battery 50 with an iron anode 51 and a manganese cathode 52. The electrolyte 53 surrounds both the iron anode and manganese cathode. The electrolyte is the sodium hydroxide based electrolyte described above, comprising sodium hydroxide, lithium hydroxide and sodium sulfide. The battery separator 54 is in one embodiment an iron-phobic battery separator having a non-polar surface. The battery separator can be made of any substance that provides such a non-polar surface. Polymers are good candidates as they provide smooth and non-polar surfaces. Suitable polymers include the polyolefins.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention and the claim appended hereto.

What is claimed is:

1. A battery which comprises an electrolyte, separator, a manganese cathode and an iron anode, with the manganese cathode comprising manganese throughout a compressed metal foam with the compression sizing of the metal foam between about 42 and 45%.

2. The battery of claim 1, when the iron anode comprises a single layer of a conductive substrate coated on at least one side with a coating comprising an iron active material and a binder.

3. The battery of claim 1, wherein the iron active material comprises a Fe metal or iron oxide species.

4. The battery of claim 1, wherein the iron anode comprises a polyvinyl alcohol binder.

5. The battery of claim 4, wherein the binder is present at a concentration of 1-10% by weight.

6. The battery of claim 1, the manganese cathode further comprising CMC.

7. The battery of claim 1, wherein the cathode comprises from about 2 to 15 weight % of graphite and/or carbon black.

8. The battery of claim 1, comprising an electrolyte comprised of sodium hydroxide, lithium hydroxide and sodium sulfide.

9. The battery of claim 1, wherein the battery separator is made of polyolefin.

10. The battery of claim 1, wherein the anode is obtained by preparing a coating mixture of an iron active material and a binder, and coating at least one side of a substrate with the coating mixture.

11. The battery of claim 10, wherein the coating of the substrate is continuous.

12. The battery of claim 10, wherein the coating is in layers of materials.

13. The battery of claim 12, wherein the layers have different properties.

14. The battery of claim 10, wherein the anode is dried after coating, where radiation is used, followed by convection drying to remove residual liquid.

15. The battery of claim 10, wherein the anode is compacted after drying and after compaction the electrode thickness is in the range of 0.005 to 0.50 inches.
